(19) United States
(12) Patent Application Publication
(10) Pub. No.: US 2012/0299216 A1
(43) Pub. Date: Nov. 29, 2012

(54) Vacuum Infusion Adhesive and Methods Related Thereto

(75) Inventors: David W. Carnahan, Port Orchard, WA (US); Robert R. Yuodelis, Port Orchard, WA (US); James C. Manlove, Port Orchard, WA (US)

(73) Assignee: WESTECH AEROSOL CORPORATION, Port Orchard, WA (US)

(21) Appl. No.: 13/174,852

(22) Filed: Jul. 1, 2011

Related U.S. Application Data
(60) Provisional application No. 61/360,910, filed on Jul. 1, 2010.

(51) Int. Cl. B29C 70/44; C09J 163/02

(52) U.S. Cl. 264/258; 523/454; 523/427

(57) ABSTRACT

An adhesive adapted to enable spray delivery and seamless polymerization during epoxy resin vacuum infusion techniques.

### CROSS-REFERENCE AND PRIORITY CLAIM TO RELATED APPLICATION

To the fullest extent permitted by law, the present U.S. Non-Provisional Patent Application claims priority to and the benefit of United States Provisional Patent Application entitled “Vacuum Infusion Adhesion and Methods Related Thereto,” filed on Jul. 1, 2010, and having assigned Ser. No. 61/360,910, wherein the referenced application is incorporated by reference herein.

### FIELD

The present disclosure relates generally to adhesives, and more particularly, to an adhesive adapted to enable seamless polymerization during epoxy resin vacuum infusion techniques.

### BACKGROUND

Vacuum infusion is a process wherein vacuum pressure is used to drive resin into a laminate structure. Typically, selected mats of random or woven fabric, such as fiberglass, carbon fiber, KEVLAR, foam core, or the like, are prepared and enclosed in a vacuum bag. Resin and catalyzer are then infused therein, typically after vacuum is drawn, and polymerization occurs after completion of an optimized curing period and at a selected temperature. The polymerization forms a rigid three-dimensional network structure defined by linear chains with cross-links therebetween.

Positioning of laminate layers is essential to allow for a properly formed structure. Therefore, spray adhesive is sometimes applied to generally hold essentially dry layers in position prior to and during the vacuum infusion process, especially for sloped assemblies, such as large boat hulls. That is, an effective adhesive must be able to hold many layers of reinforcing fabric in a vertical aspect to satisfy the need. Unfortunately, many spray adhesives that are commonly utilized in such manner form a discernable interface, weakening the overall integrity of the cured structure, acting as a contaminant in the matrix. That is, premature failure of the cured structure may result at the area(s) of adhesive application, where resin structure is interrupted.

Resins such as polyester, vinyl ester, or epoxy may be utilized for vacuum infusion. Epoxy resins, however, have better relative mechanical properties and typically produce composite structures that are stronger and more heat tolerant, with a high strength/weight ratio. Epoxy, a structural or engineering adhesive well recognized for excellent adhesion properties and high heat and chemical resistance, finds application as a coating, adhesive and in composite materials, such as those using carbon fiber and fiberglass reinforcements, as discussed further herein. Epoxy is a copolymer comprising resin and hardener. Typically, monomers or short chain polymers with an epoxide group at one end define a resin. Hardener mixes with the resin and its amine groups, such as of the polyamine monomer triethylenetetramine, to form a covalent bond with the epoxide group of the resin. In such manner, a rigid structure is defined with crosslinking therebetween, wherein the modified epoxy adheres to surfaces by forming strong polar bonds therewith.

A majority of epoxy resin is produced from epichlorohydrin and bisphenol-A, wherein bisphenol-A, or phenolacetone, is formed from 2 mole phenol and 1 mole acetone. Epichlorohydrin is a mixture of propylene and chlorine, with free radical substitution at the double bond resulting in allylchloride as a main product, which may be further treated with layer separation and processing. Typically, for liquid epoxy resin, the bisphenol-A,

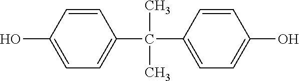

and epichlorhydrin,

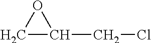

are combined with sodium hydroxide, NaOH, to preferably form epichlorohydrin,

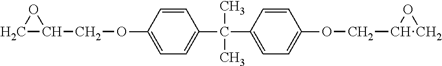

releasing Na⁺ and Cl⁻. The reaction thus removes unreacted phenol and acetone and attaches two glycidyl groups to the ends of the bisphenol-A to create a standard epoxy resin. The resulting epoxy prepolymer,

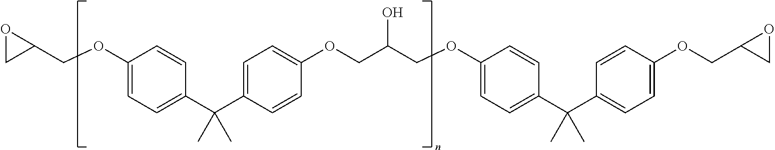

is reacted with amine compounds for cross-linking.

As noted, spray adhesives typically utilized in the vacuum infusion process to hold laminates together generally influence and negatively influence the successful formation of strong polar bonds between the epoxy and the laminate surface(s). Interruption of the epoxy resin's cross-linking may also occur, further contributing to the weakened interface. That is, as noted, the typical adhesive interface is generally weaker than the rest of the structure, compromising the integrity of the materials formed.

Therefore, it is readily apparent that there is need for a vacuum infusion adhesive that allows for secure placement of laminates and that polymerizes with epoxy resin, thereby creating a seamless cured structure and thereby avoiding the above-discussed disadvantages.

### BRIEF SUMMARY

Briefly described, in a preferred embodiment, the presently disclosed adhesive and methods related thereto overcome the above-mentioned disadvantages and meet the recognized need by enabling seamless polymerization during epoxy resin vacuum infusion techniques and by avoiding creation of any weakened adhesive interface.

According to its major aspects and broadly stated, in its preferred form, the present disclosure features a vacuum infusion adhesive that may be utilized to hold laminate layers together in a vertical aspect as resin is driven into a laminate structure. The adhesive includes properties that cross-link with epoxy resin present in the curing laminate structure. Generally, laminate layers are assembled, reinforced with carbon fiber or the like, wherein these dry materials are held together on structural or mold surfaces, curing with the resin, resulting in a single, structurally uninterrupted formation. Unlike other known adhesives, the presently described adhesive, preferably delivered as a spray, does not interfere with the curing process of the epoxy resin, but in fact cross links and hardens along with the epoxy to form a single integrated structure therewith, delivering unexpectedly improved shear strength in both fiberglass and carbon fiber applications.

More specifically, the preferred adhesive of the present disclosure features a bisphenol A/epichlorohydrin epoxy resin modified with tackifiers and adducts to form an adhesive, wherein preparation as an aerosol spray allows for application to fiberglass or carbon fiber cloth, for example, and wherein the adhesive formula facilitates use in the vacuum infusion process when epoxy resins are cured with amine hardeners.

In general, one aspect of the present disclosure features an adhesive composition comprising a solvent borne epoxy resin coupled with suitable tackifiers to effectively hold the layers of reinforcement together after the carrier solvent evaporates, and until the matrix can be placed under vacuum and infused.

In one implementation, the disclosed composition is sprayed as an adhesive on substrates such as fiberglass or carbon fiber fabrics, then the layers to be sealed are placed into a vacuum bag and epoxy resin plus hardener is infused under vacuum.

In another implementation, the epoxy base of the adhesive makes it compatible with the infusing epoxy resin and hardener, so that the adhesive polymerizes seamlessly with the epoxy resin to prevent flaws in the cured epoxy, thereby delivering unexpectedly improved results by incorporating a major component of the resin, e.g. epoxy, into a sprayable adhesive, thereby facilitating the incorporation thereof into the resin matrix without necessitating the addition of additional or extraneous compounds into the structure of the matrix.

In another implementation, the carrier solvent is acetone, whereby exemption from volatile organic compound (VOC) regulation is realized, and wherein evaporation is quick.

In another implementation, a small amount of adduct, or amine hardener is utilized to pre-polymerize a portion of the epoxy.

In another implementation, the adhesive dissolves in the infusing epoxy resin.

In another implementation, the adhesive of the present disclosure is utilized for vacuum infusion of epoxy fiberglass.

In another implementation, the composition of the present disclosure comprises epoxy carbon fiber infusion and uncured epoxy in acetone, wherein tackifiers, adducts, and/or hardeners are incorporated to provide for a tacky and/or sticky nature for the composition following evaporation of the acetone.

In another implementation, the uncured epoxy resin reacts with diamine hardeners.

In another implementation, the adhesive cross links with vacuum infusion epoxy resin.

In another implementation, one or more tackifiers, adducts, and/or hardeners are added to enhance adhesive properties of epoxy resin dissolved in acetone.

In another implementation, adducts may be added to the adhesive formula to further influence epoxy resin reactants therewith.

In another implementation, selectively compatible tackifiers may be introduced to influence tack of the epoxy adhesive.

In one implementation, the composition is a mixture of two epoxy resins.

In another implementation, the composition is a mixture of two epoxy resins, wherein one of the two epoxy resins has a carboxyl terminated butadiene nitrile (CTBN) adduct, thereby improving toughness, elasticity, and tack of the epoxy portion.

In another implementation, one or more tackifiers in the form of aliphatic C-5 or aliphatic C-5/C-9 aromatic modified hydrocarbon resins are introduced to the composition.

In another implementation, a selectively increased volume of acetone is added to the composition carrier solvent volume of acetone to reduce viscosity and thin out the adhesive, for enhanced spray can delivery of the adhesive.

In another implementation, a fumed silica filler may be introduced to help maintain a uniform spray and/or to promote improved short beam shear strength.

In another aspect, the present disclosure features a laminate structure, including a core layer having a first surface and a second surface, a cross-linking adhesive applied on at least one of the surfaces, and a reinforcing layer, such as fiberglass or carbon fiber, in contact with the at least one surface adapted with adhesive, wherein the resulting laminate structure is a cohesive resin cured unit.

In one implementation, the resin is bisphenol A/epichlorohydrin resin and the adhesive is a bisphenol A/epichlorohydrin adhesive.

One feature and advantage of the adhesive of the present disclosure is its ability to form a superior interface between laminate layers, wherein the interface is essentially incorporated into the formed epoxy-cured structure because the adhesive base is premised upon epoxy, as is the resin.

Another feature and advantage of the adhesive of the present disclosure and methods related thereto is not only the achievement of increased strength of vacuum infusion results over alternatives, with maximum tensile shear strength, but also that the adhesive remains low VOC (volatile organic components) and HAP's free (no components from EPA's hazardous air pollutants list).

Another feature and advantage of the adhesive of the present disclosure is that the adhesive begins as an independent component introduced into the vacuum infusion process for the purpose of holding the layers together until sealed within the vacuum bag, but the adhesive completes the process as a non-independent matrix member that is cross-linked with the epoxy resin.

Still another feature and advantage of the adhesive of the present disclosure is that the adhesive safely fuses laminating materials to structural core surfaces, providing superior holding prior to sealing in the vacuum bag, and further dissolves and becomes a structural component curing with the epoxy resins thereafter.

These and other features, capabilities and advantages will become more apparent to one skilled in the art from the following description and claims when read in light of the accompanying drawings.

### BRIEF DESCRIPTION OF THE DRAWINGS

The present disclosure will be better understood by reading the Detailed Description of the Preferred and Alternate Embodiments with reference to the accompanying drawing figures, in which like reference numerals denote similar structure and refer to like elements throughout, and in which:

FIG. 1 illustrates typical layers implemented in a typical embodiment of the process;

FIG. 2 illustrates an embodiment of typical epoxy resin cross-linking reactions;

FIG. 3 illustrates a first tabular presentation of initial adhesive formula performance testing with carbon fiber;

FIG. 4 illustrates a first graphical presentation of initial adhesive formula performance testing with carbon fiber;

FIG. 5 illustrates a second tabular presentation of further adhesive formula performance testing with fiberglass; and

FIG. 6 illustrates a second graphical presentation of further adhesive formula performance testing with fiberglass.

### DETAILED DESCRIPTION OF THE PREFERRED AND ALTERNATE EMBODIMENTS

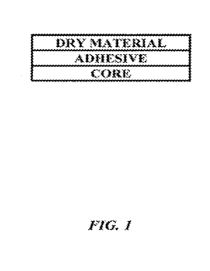

In describing the preferred and alternate embodiments of the present disclosure, as illustrated in the FIGS. 1-6 and/or described herein, specific terminology is employed for the sake of clarity. The disclosure, however, is not intended to be limited to the specific terminology so selected, and it is to be understood that each specific element includes all technical equivalents that operate in a similar manner to accomplish similar functions.

Manufacturers of epoxy-fiberglass or epoxy-carbon fiber structures using the infusion process need an adhesive product to hold fabrics together until infusion and curing is complete, but also need an adhesive product that does not act as a contaminant in the resin matrix. Having previously successfully developed INFUZENE, an adhesive comprising reactive SBS block co-polymer, hydrocarbon tackifying resin, cyclohexane and acetone that forms a cross-linked and hardened matrix along with vinyl ester resins, as described in U.S. Pat. No. 7,682,478B1, a new investigation was undertaken to develop an improved adhesive for use in epoxy resin systems rather than vinyl ester resin systems. To that end, a lengthy and complex series of trial and error experiments were conducted to conceive, analyze, identify, and create a new combination of materials that, when formulated together, would deliver heretofore unavailable results relative to vacuum infusion epoxy laminates, and according to an entirely original perspective relative to the previous vinyl ester resin adhesive. The goal, and after many modifications directed to improvement of particular characteristics including stickiness, the result was a discovery of an adhesive formulation with an epoxy-resin compatible base that would allow for efficient spray application for preparation of vacuum infusion epoxy laminates, that would be able to hold many layers of reinforcing fabric in a vertical aspect, and that would integrate into the cured epoxy laminate structure rather than form a potentially weakening interface, all with low VOC emissions.

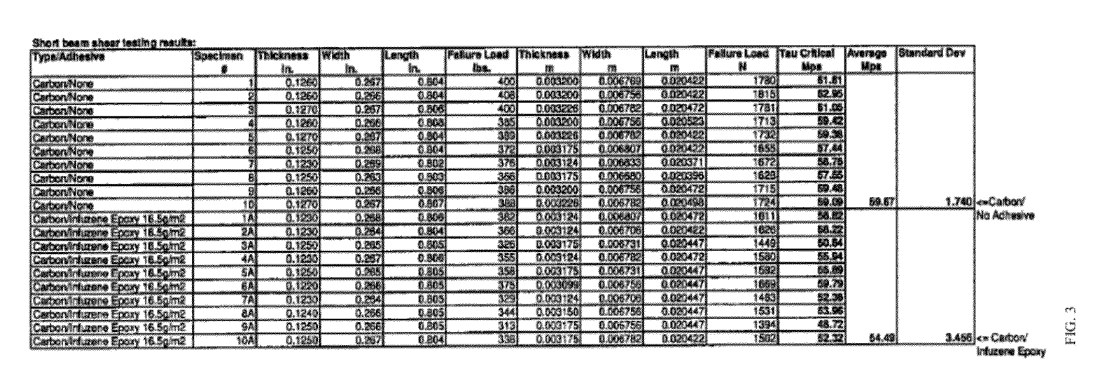

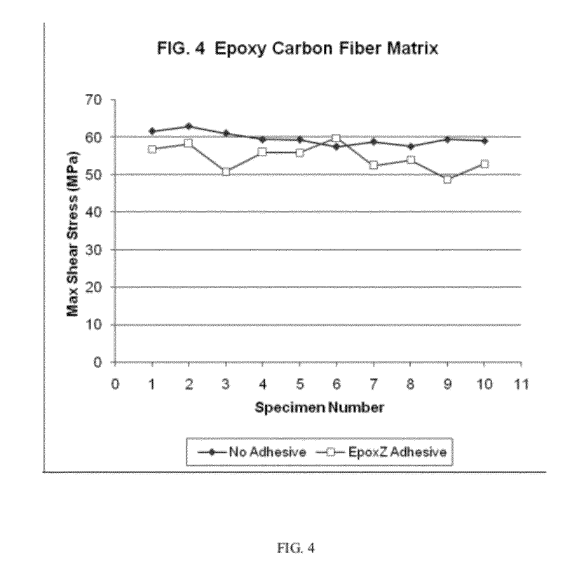

Referring now to FIGS. 3 and 4, an adhesive formula was discovered with strength recovery of about 91% in preliminary testing. This strength recovery estimate was estimated during short beam shear testing by dividing the average measured strength of ten samples of an epoxy cured carbon fiber laminate structure with adhesive 10 applied by the average measured strength of ten samples of an epoxy cured carbon fiber laminate structure without adhesive 10 (as shown, 54.59 mPA/59.67 mPA=0.915). Those skilled in the art recognize results above 90% are very good for such short beam shear testing comparisons, and further testing, discussed hereinbelow, further confirmed the unexpectedly minimal impact of adhesive 10 on the epoxy cured laminate structure.

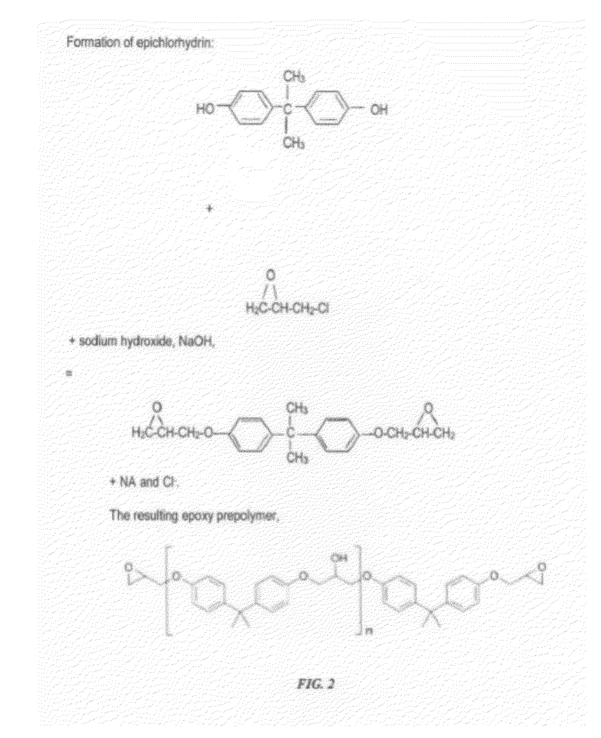

Referring now to FIGS. 1-2, vacuum infusion laminate adhesive 10 holds laminate layers together as epoxy resin is driven into a laminate structure. Adhesive 10 comprises properties that cross-link with epoxy resin as it cures. Generally, the laminate layers include the assembly of epoxy resin reinforced with fiberglass and/or carbon fiber. Present infusion molding used to fabricate epoxy resin structures is improved with the use of adhesive 10 and the methods related thereto described herein.

The presently described technique encapsulates carbon fiber and/or fiberglass with epoxy resin while the resin cures, resulting in superior structural strength while allowing for low VOC emissions. The presently described process enables the use of epoxy adhesive 10 to hold components in place in a vertical aspect while the laminate is bagged and subsequently infused with epoxy resin under vacuum. Cross linkable adhesive 10 enables the creation of strong connections between laminate layers, wherein epoxy adhesive 10 preferably cures with epoxy resin and becomes an integral part of the cured structure, as discussed further herein. During curing, low shrinkage is observed. In addition, maximum tensile shear strength may be obtained.

In a typical embodiment, adhesive 10 is enclosed within a spray can and is applied to hold dry materials together and onto structural surfaces, ultimately curing with the epoxy resin to result in a single, uninterrupted structural formation. The polymeric, epoxy spray of adhesive 10 does not interfere with or contaminate the curing process of epoxy resins, wherein adhesive 10 instead cross links and/or otherwise structurally integrates and hardens along with the epoxy resin to form an integrated chemical structure.

It should be understood that adhesive 10 may be enclosed in a canister or other suitable container, or otherwise applied in a manner desirable relative to the workpiece.

Adhesive 10 is preferably comprised of a formulated bisphenol A/epichlorohydrin epoxy resin base, preferably modified with tackifiers and adducts. The unique compatibility of the base of adhesive 10 with the epoxy resin of the target vacuum infusion procedure facilitates delivery of superior infusion results. However, it is the further modifications to that base that provide for the preferred tacky nature of adhesive 10 after the carrier solvent, preferably acetone, has evaporated. That is, in a typical implementation, adhesive 10 is prepared by dissolving epoxy and one or more tackifiers in a solvent, preferably acetone. Acetone is quick to evaporate, is exempt from VOC regulation, and is therefore preferred as a carrier solvent. However, it should be recognized by one skilled in the art that other carrier solvents could be utilized.

According to the preferred embodiment, adhesive 10 is a mixture of two epoxy resins, one of which has a carboxyl terminated butadiene nitrile (CTBN) adduct. Although a different combination or a single resin may alternately be utilized, the preferred mixture delivers improved toughness, elasticity, and tack of the epoxy portion of adhesive 10. Additionally, tackifier selection preferably optimizes stickiness or tack of adhesive 10, wherein tackifiers in the form of aliphatic C-5 or aliphatic C-5/C-9 aromatic modified hydrocarbon resins are preferred, but other commonly known tackifiers may perform suitably.

One or more adducts, or amine hardeners, may be included in adhesive 10, to pre-polymerize a portion of the epoxy. It should be noted that curing of adhesive 10 may actually start before introduction of curing agent to the epoxy resin. In such an embodiment, the complete “dissolving” of the epoxy adhesive into the chemical structure of the cured laminate is ensured, wherein potential flaws in the matrix are eliminated, or at least greatly diminished relative to prior adhesives.

When the composition is to be delivered by a spray can, as preferred, adhesive 10 is formulated with a lower viscosity to enable pressurized placement with gas for satisfactory adhesive spray, wherein viscosity is preferably influenced and balanced in the formula of adhesive 10 with the addition of more acetone carrier. In the preferred embodiment, especially for spray delivery, the fumed silica filler CABOSIL is added, resulting in maintenance of a uniform spray and promotion of improved short beam shear strength.

In another embodiment, when the composition is packaged in a canister, a small amount of propane-isobutane, or other gas and/or hydrocarbon is used and pressurized with nitrogen or other suitable gas to a higher pressure. In such an embodiment, a higher viscosity may be utilized, thereby accommodating a higher solids level in the basic composition. That is, the higher the concentration in terms of weight percent solids to the total weight of the mix, the higher the viscosity, wherein canisters can generally withstand higher pressure than cans.

In use, laminates, or composites, are preferably prepared from layers of carbon fiber material held together with adhesive 10. These composites are vacuum infused with epoxy resin. Samples prepared according to such process and with adhesive 10, after curing, were subjected to testing using ASTM D 2334, “Standard Test Method for Short-Beam Strength of Polymer Matrix Composite Materials and Their Laminates,” to determine the “short-beam strength of the high-modulus fiber-reinforced composite materials”, wherein no weak spots were detected in the compositions formed using adhesive 10. That is, the interlaminar shear strength was determined by comparative flexing of composite specimens by delivery of controlled forces thereto until breakage occurred, and confirmation of the structural integration of adhesive 10 into the cured laminate structure was realized.

### Exemplary Test Data

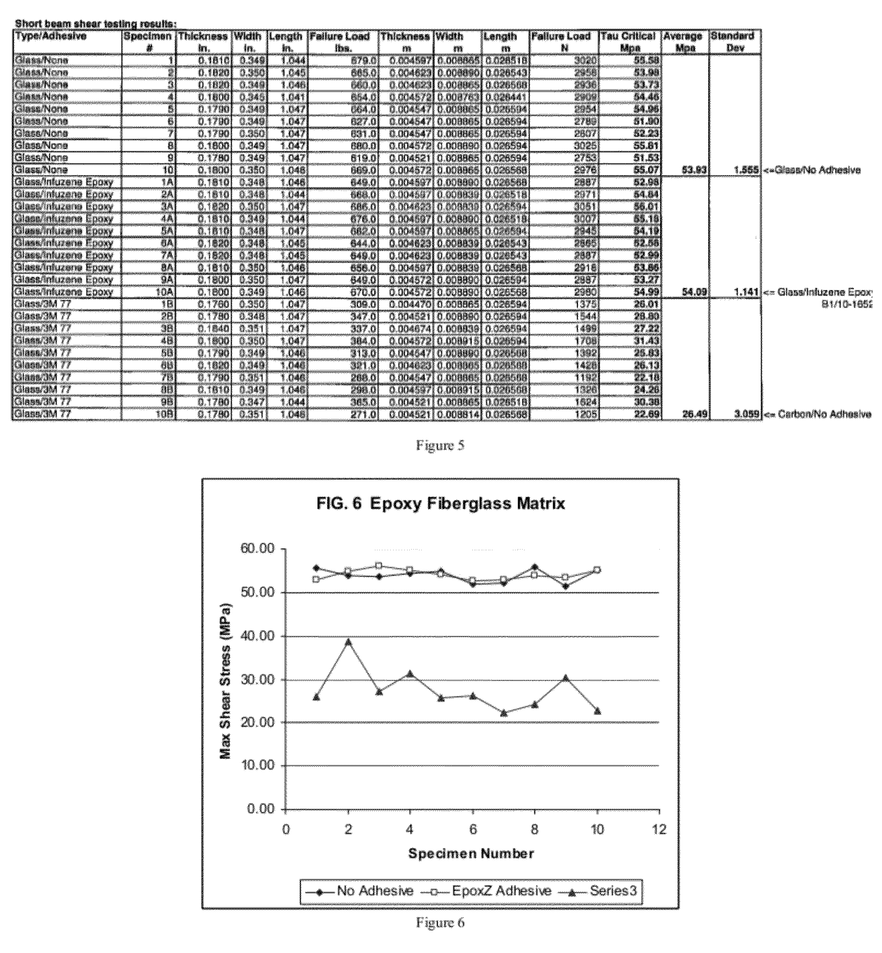

In order to test the efficacy of epoxy adhesive 10, laminate samples were prepared and analyzed following a procedure similar to ASTM D 2334. Fiberglass laminate layers were prepared: first, with no adhesive, second, with epoxy adhesive 10, and third, with representative multi-purpose aerosol adhesive, 3M SUPER 77. Ten samples were tested for each variation. Maximum shear stress (MPa) repeatedly confirmed the unexpected benefits of epoxy adhesive 10, as compared to the representative traditional, multi-purpose adhesive. Sample data and measured results are presented in FIG. 5, with graphical representation in FIG. 6. With strength recovery double that of traditional adhesive, the performance of adhesive 10, with 99% strength recovery, is unexpectedly synergistic and improved for use in epoxy laminate applications relative to the performance of a traditional adhesive, with strength recovery of only about 49%.

In the procedure, laminates and fiberglass were thus either sprayed with adhesive 10, sprayed with representative traditional adhesive, or placed together with no adhesive. The assembled laminates were placed into a vacuum bag, and epoxy resin and hardeners were appropriately introduced. Vacuum remained until resin curing was complete. The completed samples, of dimensional specifications as noted in FIG. 5, were subjected to short beam shear testing, with failure load recorded for each sample, also as displayed in FIG. 5. The performance of adhesive 10 relative to the control epoxy laminate structure without adhesive was remarkable, and the magnitude of improvement of shear strength with adhesive 10 as compared to traditional adhesive was unexpected. The testing results indicate that adhesive 10 may be utilized in epoxy laminate applications essentially without impact on the resulting laminate structure.

Having thus described exemplary embodiments of the present apparatus and method, it should be noted by those skilled in the art that the within disclosures are exemplary only, and that various other alternatives, adaptations, and modifications may be made within the scope of the present disclosure. Accordingly, the present disclosure is not limited to the specific embodiments illustrated herein, but is limited only by the following claims.

We claim:

1. An improved epoxy resin vacuum infusion process, comprising:
preparing a laminate structure, said laminate structure further comprising,
a core layer having a first and a second surface;
a cross-linked adhesive applied to at least one of said surfaces; and
a reinforcing layer in contact with said at least one of said surface containing said adhesive, wherein said adhesive further comprises an epoxy resin and a tack enhancing substance;
placing said laminate structure within a vacuum bag;
drawing a vacuum on said vacuum bag with a vacuum source;
driving an epoxy resin into said vacuum bag, infusing said laminate structure; and
curing said epoxy resin and forming a matrix comprising said adhesive, cross-linked and hardened along with said epoxy resin as an integrated structure.

2. The process of claim 1, wherein each said epoxy resin is bisphenol A/epichlorohydrin.

3. The process of claim 1, wherein said cross-linking is free-radical initiated.

4. The process of claim 1, further comprising the preliminary step of dissolving said adhesive in an acetone carrier.

5. The process of claim 1, further comprising the step of initiating a catalyst system for said epoxy resin before driving said epoxy resin into said vacuum bag.

6. A cross-linking adhesive composition comprising:
epoxy resin; and
tackifier,
wherein said adhesive is dissolved in an organic ketone.

7. The adhesive of claim 6, wherein said epoxy resin is bisphenol A/epichlorohydrin.

8. The adhesive of claim 6, further comprising one or more adducts.

9. The adhesive of claim 6, wherein said organic ketone is acetone.

10. The adhesive of claim 8, wherein said epoxy resin is a mixture of two epoxy resins, and wherein one of said two epoxy resins has a carboxyl terminated butadiene nitrile adduct.

11. The adhesive of claim 6, wherein said tackifier is selected from the group consisting of aliphatic C-5 or aliphatic C-5/C-9 aromatic modified hydrocarbon resins.

12. The adhesive of claim 6, further comprising fumed silica filler.

13. A process of preparing a laminate structure, comprising the steps of:
obtaining one or more core layers and one or more reinforcing layers;
applying a thin spray of an adhesive between and assembling said one or more core layers and said one or more reinforcing layers into said laminate structure,
wherein said adhesive comprises an epoxy, a tackifying resin, and one or more solvents,
wherein said one or more solvents evaporate, and
wherein said adhesive holds said laminate structure together;
applying a vacuum to said vacuum bag, causing said bag to pull against said laminate structure;
delivering an epoxy resin by said vacuum, said epoxy resin infusing said plurality of layers of said laminate structure;
allowing said epoxy resin to cure, wherein as said resin cures, said epoxy of said adhesive is incorporated into a chemical structure of said epoxy resin, facilitating formation of a generally continuous cured structure.

14. The process of claim 13, wherein said one or more reinforcing layers are selected from the group consisting of fiberglass, carbon fiber, and KEVLAR.

15. The process of claim 13, wherein said one or more solvents is acetone.

16. The process of claim 13, wherein said adhesive further comprises one or more adducts.

17. The process of claim 13, wherein said epoxy of said adhesive is bisphenol A/epichlorohydrin.

18. The process of claim 13, further comprising amine hardener to prepolymerize a portion of said epoxy.

19. The process of claim 13, wherein said epoxy of said adhesive is a mixture of at least two epoxy resins.

20. The process of claim 19, wherein at least one of said at least two epoxy resins has a carboxyl terminated butadiene nitrile adduct.
